(19) United States
(12) Patent Application Publication
(10) Pub. No.: US 2025/0125603 A1
(43) Pub. Date: Apr. 17, 2025

(54) CLAMP

(71) Applicant: TA Aerospace, Valencia, CA (US)

(72) Inventors: Edwin F. Vardayou, Valencia, CA (US); Tabassum Qureshi, Valencia, CA (US)

(21) Appl. No.: 18/914,673

(22) Filed: Oct. 14, 2024

Related U.S. Application Data
(60) Provisional application No. 63/590,050, filed on Oct. 13, 2023.

(51) Int. Cl. H02G 3/32; F16L 3/10

(52) U.S. Cl. CPC H02G 3/32; F16L 3/1075

(57) ABSTRACT

Provided is a clamp including a band assembly including a lower band, a first upper band pivotally coupled to the lower band, and a second upper band, the lower band, first upper band, and second upper band defining a passage for receiving a payload, a cushion assembly at least partially surrounding the band assembly, and a fastener removably coupling the first and second upper bands and configured to adjust a size of the passage.

### RELATED APPLICATION

This application claims the benefit of U.S. Provisional Patent Application No. 63/590,050, filed Oct. 13, 2023, the disclosure of which is incorporated herein by reference.

### FIELD OF INVENTION

The present invention relates generally to a clamp, and more particularly to clamp for retaining wires on a structure.

### BACKGROUND

A clamp may be provided for retaining wires and the like in various industries, including the automobile and aircraft industry. In the aircraft industry, after a fuselage has been assembled and various wires positioned along the fuselage, the clamp may be positioned around the wires and then secured to the fuselage.

### SUMMARY OF INVENTION

According to an aspect, a clamp is provided that includes a band assembly including a lower band, a first upper band pivotally coupled to the lower band, and a second upper band, the lower band, first upper band, and second upper band defining a passage for receiving a payload, a cushion assembly at least partially surrounding the band assembly, and a fastener removably coupling the first and second upper bands and configured to adjust a size of the passage.

According to another aspect, a clamp is provided that includes a band assembly including a lower band having a first end and a second end, a first upper band having a first end and a second end pivotally coupled to the second end of the lower band, and a second upper band having a first end and a second end removably coupled to the first end of the first upper band, the lower band, first upper band, and second upper band defining a passage for receiving a payload, and a fastener removably coupling the first and second upper bands and configured to adjust a size of the passage.

According to still another aspect, a clamp is provided that includes a band assembly including a lower band having a first end and a second end, and an upper band having a first end removably coupled to the first end of the lower band and a second end pivotally coupled to the second end of the lower band, the lower band and upper band defining a passage for receiving a payload, a cushion assembly at least partially surrounding the band assembly, and a fastener removably coupling the first and second upper bands and configured to adjust a size of the passage.

The foregoing and other features of the application are described below with reference to the drawings.

### BRIEF DESCRIPTION OF THE DRAWINGS

FIG. 1 is a perspective view of an exemplary clamp in a closed position.

FIG. 2 is a rear view of the clamp.

FIG. 3 is a front view of the clamp.

FIG. 4 is a right side view of the clamp.

FIG. 5 is a left side view of the clamp.

FIG. 6 is a top view of the clamp.

FIG. 7 is a bottom view of the clamp.

FIG. 8 is an exploded view of a band assembly of the clamp.

FIG. 9 is a perspective view of the clamp in an open position.

FIG. 10 is a perspective view of the clamp in the open position with a payload.

FIG. 11 is a perspective view of the clamp in the closed position with the payload.

FIG. 12 is a perspective view of another exemplary clamp in a closed position.

FIG. 13 is a perspective view of the clamp in an open position.

### DETAILED DESCRIPTION

The principles of the present application relate to a clamp, such as a loop clamp for an aircraft and thus will be described below in this context. It will be appreciated that the principles of the application may be applicable to other industries for retaining various objects, such as in the automobile industry, building sector, space industry, etc.

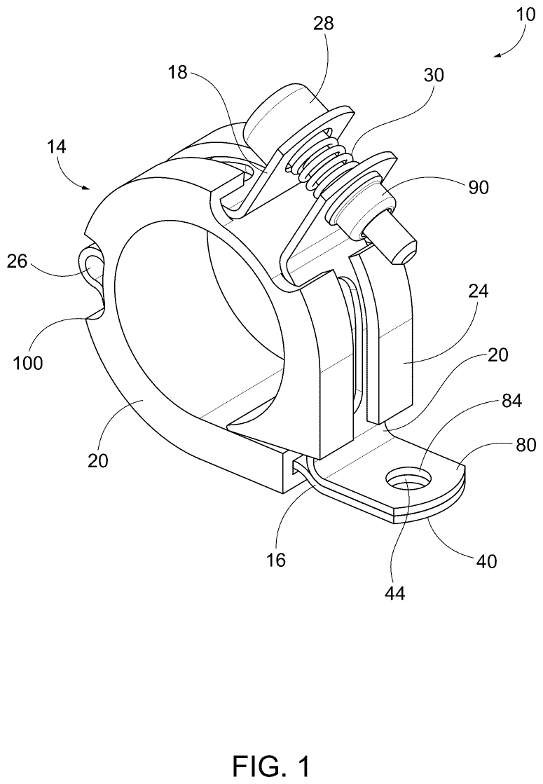

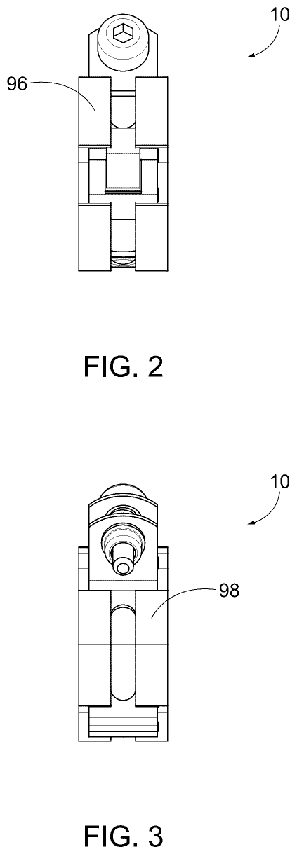

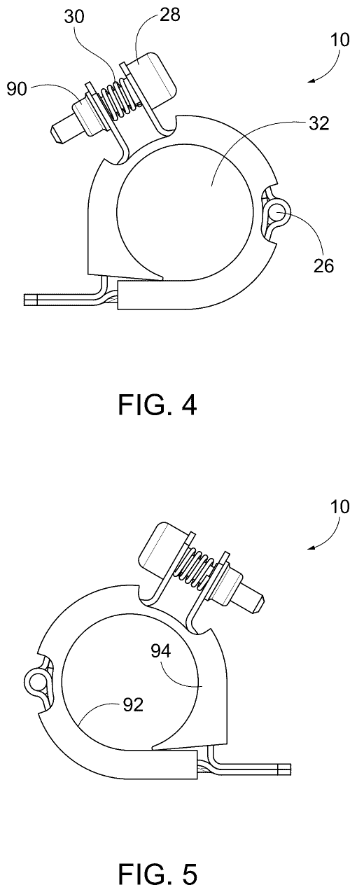

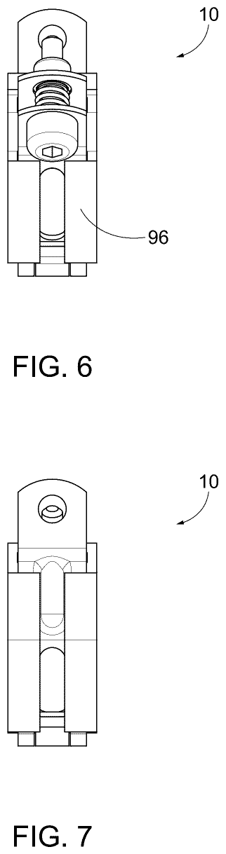

Turning initially to FIGS. 1-7, a clamp is shown generally at reference numeral 10. The clamp may be a suitable clamp, such as a variable diameter loop clamp that can secure payloads, such as wires, hoses, etc., of varying sizes. The clamp 10 may be attached to a surface, such as a panel that forms part an aircraft fuselage during a first pre-install stage, and the payload may be received by the clamp 10 during a second aircraft assembly stage after the payload has been positioned and various other components have been attached to the panel.

The clamp 10 includes a band assembly 12 and a cushion assembly 14 at least partially surrounding the band assembly 12. The band assembly 12 includes a lower band 16, a first upper band 18, and second upper band 20, and the cushion assembly 14 includes a first cushion 22 surrounding part of the lower band 16 and the first upper band 18, and a second cushion 24 surrounding a part of the second upper band 20. The lower band 16 is pivotally coupled to the first upper band 18 by a pivot pin 26, and the first upper band 18 is removably coupled to the second upper band 20 by a fastener 28. It will be appreciated that the lower band 16 and the first upper band 18 may be pivotally coupled in other suitable manners, such as a pinless design. The fastener 28 is surrounded by a resilient member 30, such as a compression spring, which may be secured on the fastener 28 in a suitable manner, such as by a retaining ring. When assembled, the band assembly 12 defines a passage 32 for receiving the payload.

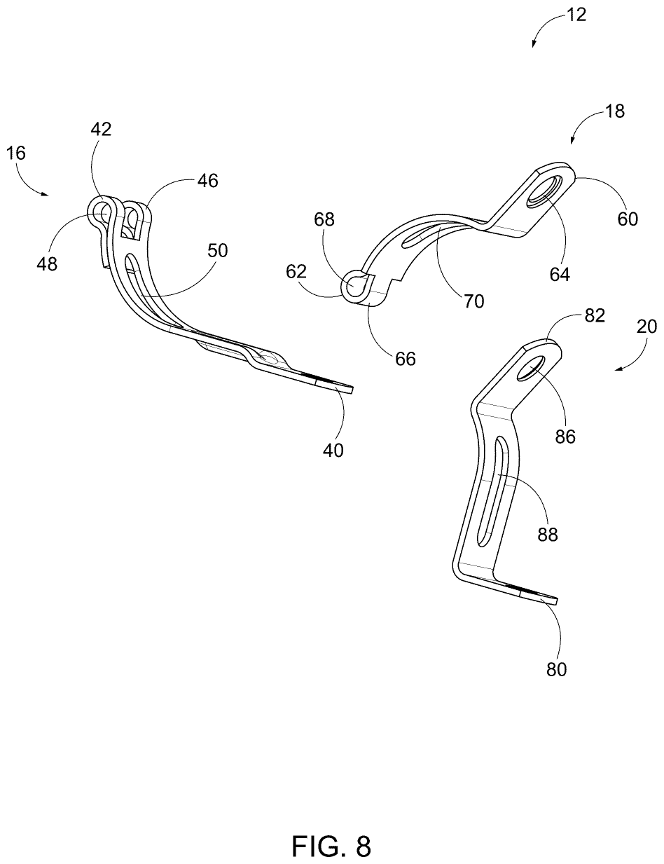

Turning additionally to FIG. 8, the band assembly 12 will be described in detail. The lower band 16, the first upper band 18, and the second upper band 20 may be made of a suitable material, such as metal, such as stainless steel. The lower band 16 has first and second ends 40 and 42 and is curved along its length. The lower band 16 includes an opening 44 at the first end 40, a pair of spaced ears 46 at the second end 42 each having an opening 48 for receiving the pivot pin 26, and at least one opening 50 for weight reduction along the length of the lower band 16. The spaced ears 46 may be formed by bending a portion of the lower band 16 onto itself and attaching the portions in a suitable manner, such as by welding.

The first upper band 18 has first and second ends 60 and 62 and is curved along its length. The first upper band 18 includes an opening 64 at the first end 60, an ear 66 at the second end 62 having an opening 68 for receiving the pivot pin 26, and at least one opening 70 for weight reduction along the length of the first upper band 18. The ear 66 may be formed by bending a portion of the first upper band 18 onto itself and attaching the portions in a suitable manner, such as by welding. Alternatively, it will be appreciated that the first upper band 18 may include a pair of spaced ears and the lower band 16 may include an ear received between the spaced ears of the first upper band 18. The fastener 28, which may be a suitable fastener such as a captive screw, may be received in the opening 64 at the first end 60, and may be secured to the first upper band 18 in a suitable manner, such as by a retaining ring, nut retainer, etc.

The second upper band 20 has first and second ends 80 and 82 and is curved along its length. The second upper band 20 includes an opening 84 at the first end 80, an opening 86 at the second end 82, and at least one opening 88 for weight reduction along the length of the second upper band 20. A fastener retainer 90, which may be a suitable retainer such as a threaded clinch nut, is secured to the second upper band 20 at the opening 86 for threadably coupling to the fastener 28. Alternatively, it will be appreciated that the fastener 28 may be secured in the opening 86 in the second upper band 18 and the fastener retainer 90 secured in the opening 64 in the first upper band.

Turning now to the cushion assembly 14, the cushion assembly 14 is provided to prevent damage to components received by the clamp 10, and may be made of a suitable material, such as an elastomer. The first and second cushions 22 and 24 may be made in any suitable manner, such as by molding, and may have a suitable shape, for example substantially C-shaped in cross section. Each cushion may have a respective base 92, 94 that abuts or is in close proximity to an inner surface of the band assembly 12, and a respective pair of substantially L-shaped arms 96, 98 having ends facing one another and spaced from one another to overlap the sides of the band assembly 12 and cover a portion of the outer surface of the band assembly 12. The L-shaped arms 96 of the first cushion 22 may also have a gap 100 to provide an open area where the lower band 16 and first upper band 18 couple at the pivot.

To assembly the clamp 10, the ear 66 on the first upper band 18 is positioned between the pair of ears 46 in the lower band 16 and the pivot pin 26 is inserted through the openings 48 and 68 in the lower band 16 and first upper band 18 respectively. The first end 60 of the first upper band 18 is aligned with the second end 82 of the second upper band and the fastener 28 is threadably coupled to the fastener retainer 90 to removably couple to first upper band 18 to the second upper band 20. The first cushion 22 may then be positioned over the lower band 16 and the first upper band 18 and the second cushion 24 positioned over the second upper band 20, with a portion of the second cushion 24 overlapping a portion of the first cushion 22 and being wedge shaped. It will be appreciated that the lower band 16, the first upper band 18, the second upper band 20, the first cushion 22, and the second cushion 24 may be assembled in any suitable order.

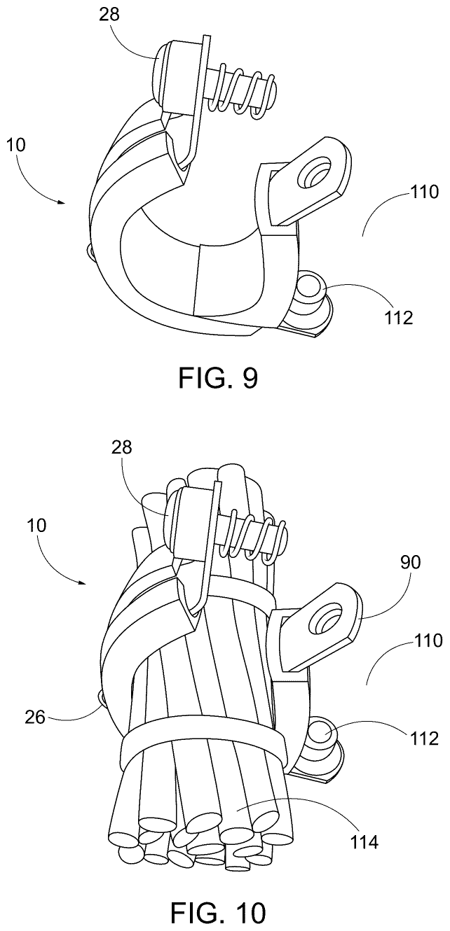

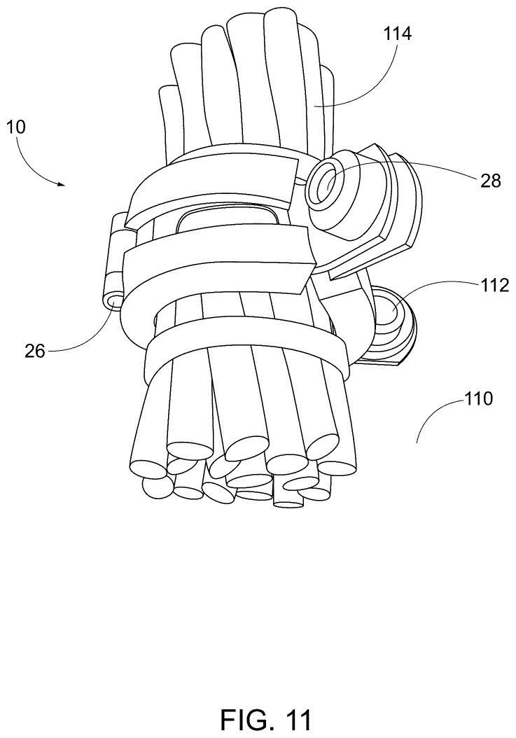

Turning additionally to FIGS. 9-11, assembly of the clamp 10 to a structure 110, such as a panel of a fuselage, will be described in detail. To assemble the clamp 10 to the structure 110 during the first pre-install stage, the opening 44 at the first end 40 of the lower band 16 is aligned with the opening 84 at the first end 80 of the second upper band 20 and a fastener 112 inserted through the openings 44 and 84 and secured to the structure 110. The fastener 28 can then be uncoupled from the fastener retainer 90, or alternatively can be uncoupled when the lower band 16 and second upper band 20 are being secured to the structure 110.

During a second aircraft assembly stage, the first upper band 18 is pivoted away from the second upper band 20 about pivot pin 26, and a payload 114, shown as a bundle of wires, is inserted into the passage 32. The fastener 28 is then coupled to the fastener retainer 90 to hold the payload 114 in the passage 32. The fastener can be tightened/loosed relative to the fastener retainer 90 to allow for various size payloads. For example, for smaller diameter payloads, the fastener 28 may be tightened to be a first distance from the fastener retainer 90 to compress the resilient member 30, and for larger diameter payloads, the fastener 28 may be tightened to be a second distance, larger than the first distance, from the fastener retainer 90 where the resilient member 30 is uncompressed. This installation method reduces install time and reduces injuries caused by objects encountered during the second aircraft assembly stage, and the fastener 28 and fastener retainer 90 provide a secondary opening feature to release the payload at any time.

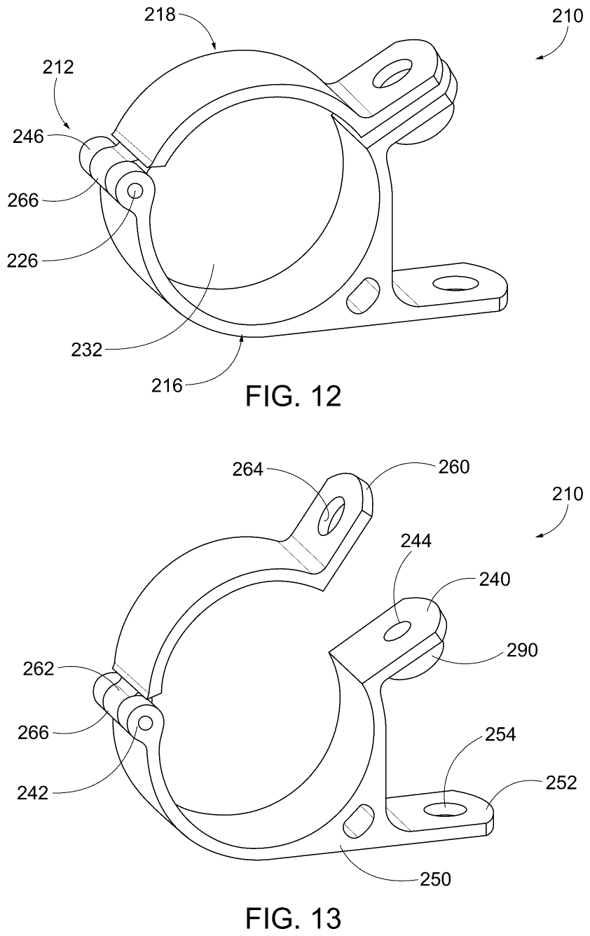

Turning now to FIGS. 12 and 13, an exemplary embodiment of the clamp is shown at 210. The clamp 210 is substantially the same as the above-referenced clamp 10, and consequently the same reference numerals but indexed by 200 are used to denote structures corresponding to similar structures in the clamps. In addition, the foregoing description of the clamp 10 is equally applicable to the clamp 210 except as noted below.

The clamp 210 includes a band assembly 212 and a cushion assembly (not shown) at least partially surrounding the band assembly 212. The band assembly 212 includes a lower band 216 and an upper band 218, and the cushion assembly includes a first cushion surrounding part of the lower band 216, and a second cushion surrounding a part of the upper band 218. The lower band 216 is pivotally coupled to the upper band 218 by a pivot pin 226 at one and, and removably coupled to the upper band 218 at the other end by a fastener. It will be appreciated that the lower band 216 and the upper band 218 may be pivotally coupled in other suitable manners, such as a pinless design. The fastener may be surrounded by a resilient member, such as a compression spring, which may be secured on the fastener in a suitable manner, such as by a retaining ring. When assembled, the band assembly 212 defines a passage 232 for receiving the payload.

Turning now to the band assembly 212, the lower band 216 and the upper band 218 may be made of a suitable material, such as plastic. The lower band 216 has first and second ends 240 and 242 and a body 250 therebetween and is curved along its length. The lower band 216 includes an opening 244 at the first end 240, and a pair of spaced ears 246 at the second end 242 each having an opening for receiving the pivot pin 226. The lower band 216 also includes a foot 252 extending from the body 250 below the first end 240, the foot 252 having an opening 254. The lower band 216 is formed such that it is substantially C-shaped between the first and second ends 240 and 242, with the bottom of the foot 252 and a portion of the bottom of the body 250 being substantially planar for abutting a surface.

A fastener retainer 290 having threads may be formed with the lower band 216 at the opening 244 for threadably coupling to the fastener. Alternatively, it will be appreciated that the fastener may be secured in the opening 244 in the lower band 216 and the fastener retainer 290 may be formed with the upper band 218 at the opening 264.

The upper band 218 has first and second ends 260 and 262 and is curved along its length. The upper band 218 includes an opening 264 at the first end 260, and an ear 266 at the second end 262 having an opening for receiving the pivot pin 226. Alternatively, it will be appreciated that the upper band 218 may include a pair of spaced ears and the lower band 216 may include an ear received between the spaced ears of the upper band 218. The fastener, which may be a suitable fastener such as a captive screw, may be received in the opening 264 at the first end 260, and may be secured to the upper band 218 in a suitable manner, such as by a retaining ring, nut retainer, etc.

Turning now to the cushion assembly, the first and second cushions and may be made in any suitable manner, such as by molding, such as by overmolding on the band assembly 212, and may have a suitable shape, for example substantially C-shaped in cross section. Each cushion may have a respective base that abuts or is in close proximity to an inner surface of the band assembly 212, and a respective pair of substantially L-shaped arms having ends facing one another and spaced from one another to overlap the sides of the band assembly 212 and cover a portion of the outer surface of the band assembly 212.

To assembly the clamp 210, the ear 266 on the upper band 218 is positioned between the pair of ears 246 in the lower band 216 and the pivot pin 226 is inserted through the openings in the ears in the lower band 216 and first upper band 218 respectively. The first end 260 of the upper band 218 is aligned with the first end 244 of the lower band 216 and the fastener is threadably coupled to the fastener retainer 290 to removably couple to upper band 218 to the lower band 216 at their first ends. The first cushion may then be positioned over the lower band 216 and the second cushion positioned over the upper band 218. It will be appreciated that the lower band 216, the upper band 218, the first cushion, and the second cushion may be assembled in any suitable order.

To assemble the clamp 210 to the structure during the first pre-install stage, a fastener is inserted through the opening 254 in the foot 252 of the lower band 216 and secured to the structure. The fastener removably coupling the lower band 216 and upper band 218 can then be uncoupled from the fastener retainer 290, or alternatively can be uncoupled when the lower band 216 is being secured to the structure.

During a second aircraft assembly stage, the upper band 218 is pivoted away from the lower band 216 about the pivot pin 226, and a payload, such as a bundle of wires, is inserted into the passage 232. The fastener is then coupled to the fastener retainer 290 to hold the payload in the passage 332. The fastener can be tightened/loosed relative to the fastener retainer 290 to allow for various size payloads.

Although certain embodiments have been shown and described, it is understood that equivalents and modifications falling within the scope of the appended claims will occur to others who are skilled in the art upon the reading and understanding of this specification.

What is claimed is:

1. A clamp comprising:
a band assembly including a lower band, a first upper band pivotally coupled to the lower band, and a second upper band, the lower band, first upper band, and second upper band defining a passage for receiving a payload;
a cushion assembly at least partially surrounding the band assembly; and
a fastener removably coupling the first and second upper bands and configured to adjust a size of the passage.

2. The clamp according to claim 1, wherein the lower band has first and second ends, the first upper band has first and second ends, and the second upper band has first and second ends, wherein the second end of the lower band is pivotally coupled to the second end of the first upper band, wherein the first end of the first upper band is removably coupled to the second end of the second upper band by the fastener, and wherein the second end of the lower band is configured to be coupled to the first end of the second upper band.

3. The clamp according to claim 2, wherein the lower band has an opening at the first end, the first upper band has an opening at the first end, and the second upper band has an opening at the first end and the second end, wherein the opening at the first end of the first upper band is aligned with the opening at the second end of the second upper band to receive the fastener, and wherein the opening at the first end of the lower band is configured to be aligned with the opening at the first end of the second upper band to receive a fastener to couple the clamp to a structure.

4. The clamp according to claim 2, wherein the lower band includes a pair of spaced ears at the second end and the first upper band includes an ear at the second end that is received between the pair of spaced ears on the lower band, and wherein a pivot pin is received in openings in the pair of spaced ears and the ear to pivotally couple the lower band and the first upper band.

5. The clamp according to claim 1, wherein the cushion assembly includes a first cushion at least partially surrounding the lower band and the first upper band, and a second cushion at least partially surrounding the second upper band.

6. The clamp according to claim 1, wherein the fastener is a captive screw.

7. The clamp according to claim 6, further comprising a fastener retainer secured to the second upper band, wherein the captive screw is threadably coupled to the fastener retainer.

8. The clamp according to claim 1, further comprising a resilient member surrounding the fastener, the resilient member being configured to compress as the fastener is tightened.

9. The clamp according to claim 1, wherein the lower band, first upper band, and second upper band are metal.

10. A clamp comprising:
a band assembly including a lower band having a first end and a second end, a first upper band having a first end and a second end pivotally coupled to the second end of the lower band, and a second upper band having a first end and a second end removably coupled to the first end of the first upper band, the lower band, first upper band, and second upper band defining a passage for receiving a payload; and
a fastener removably coupling the first and second upper bands and configured to adjust a size of the passage.

11. The clamp according to claim 10, wherein the lower band has an opening at the first end, the first upper band has an opening at the first end, and the second upper band has an opening at the first end and the second end, wherein the opening at the first end of the first upper band is aligned with the opening at the second end of the second upper band to receive the fastener, and wherein the opening at the first end of the lower band is configured to be aligned with the opening at the first end of the second upper band to receive a fastener to couple the clamp to a structure.

12. The clamp according to claim 11, wherein the lower band includes a pair of spaced ears at the second end and the first upper band includes an ear at the second end that is received between the pair of spaced ears on the lower band, and wherein a pivot pin is received in openings in the pair of spaced ears and the ear to pivotally couple the lower band and the first upper band.

13. The clamp according to claim 10, further comprising a cushion assembly at least partially surrounding the band assembly.

14. The clamp according to claim 13, wherein the cushion assembly includes a first cushion at least partially surrounding the lower band and the first upper band, and a second cushion at least partially surrounding the second upper band.

15. The clamp according to claim 10, wherein the fastener is a captive screw.

16. The clamp according to claim 15, further comprising a fastener retainer secured to the second upper band, wherein the captive screw is threadably coupled to the fastener retainer.

17. The clamp according to claim 10, wherein the lower band, first upper band, and second upper band are metal.

18. A clamp comprising:
a band assembly including a lower band having a first end and a second end, and an upper band having a first end removably coupled to the first end of the lower band and a second end pivotally coupled to the second end of the lower band, the lower band and upper band defining a passage for receiving a payload;
a cushion assembly at least partially surrounding the band assembly; and
a fastener removably coupling the first and second upper bands and configured to adjust a size of the passage.

19. The clamp according to claim 18, wherein the lower band and upper band each have an opening at the respective first end aligned with one another to receive the fastener, and wherein the lower band includes a foot with an opening to receive a fastener to couple the clamp to a structure.

20. The clamp according to claim 18, wherein the lower band and upper band are plastic.
